(19) United States
(12) Patent Application Publication
(10) Pub. No.: US 2020/0372371 A1
(43) Pub. Date: Nov. 26, 2020

(54) SYSTEM AND A METHOD FOR OPTIMIZING MULTIPLE SOLUTION IDENTIFICATION IN A SEARCH SPACE

(71) Applicant: Cognizant Technology Solutions India Pvt. Ltd, Chennai (IN)

(72) Inventors: Sakthivel Sabanayagam, Hyderabad (IN); Saroj Pradhan, Kolkata (IN); Sougata Maitra, Kolkata (IN); Angusamy Vimal Kumar, Erode (IN); Sourav Chatterjee, Hooghly (IN)

(21) Appl. No.: 16/540,219

(22) Filed: Aug. 14, 2019

(30) Foreign Application Priority Data
May 23, 2019 (IN) 201941020477

(51) Int. Cl. G06N 3/12; G06F 17/18

(52) U.S. Cl. CPC G06N 3/126; G06F 17/18

(57) ABSTRACT

A system and method for optimizing solution identification for a problem is provided. The invention comprises generating multiple solutions for the problem by selecting population of datasets from a search space. Further, fitness of each generated solution is determined by utilizing a fitness approximation model for selecting solutions from the generated solutions for generating a next generation of solutions until the solutions converge based on a pre-determined convergence target. Further, solutions from the converged solutions are filtered by utilizing a filtering model for performing a concrete evaluation. The concrete evaluation is performed for identifying productive solutions and unproductive solutions from the solutions filtered from the converged solutions. Further, a feedback based on the concrete evaluation is provided. Furthermore, the solution identification for a problem is carried out iteratively until a termination condition is met.

### FIELD OF THE INVENTION

The present invention relates generally to the field of solution identification in a search space. More particularly, the present invention relates to a system and a method for optimizing multiple solution identification in an n-dimensional search space by employing feedback driven evolutionary computing and adversarial machine learning techniques.

### BACKGROUND OF THE INVENTION

Solution optimization and identification for one or more problems in a large n-dimensional search space may generally be carried out by applying stochastic evolutionary computing techniques such as, but are not limited to, metaheuristic genetic algorithm techniques or the like. The genetic algorithm techniques identifies fit solution by evolving population of candidate solutions (phenotypes) and generating fit population of solutions based on a pre-defined fitness criteria. The generation of new solutions is carried out by applying biological processes such as, population initialization, fitness calculation, parent selection, crossover, mutation and offspring generation. Further, the generated offspring replaces the existing population of solutions to form a next generation of solutions. The fit population generated comprises multiple fit solutions which are arrived at for the problem. However, it has been observed that, the generated solution may not comprise all feasible solutions to the problem.

Further, it has been observed that conventional methods of applying genetic algorithm techniques are not sufficient for generating maximum possible solutions to various complex problems that require multiple solution search and identification in a large n-dimensional search space. The complex problems for which solutions have to be identified may include, but are not limited to, functional test data generation for a software application, optimizing the proportional-integral-derivative (PID) controller parameters for quadcopter (drone) flight motion, game playing agents, vehicle routing, multiple object optimization, telecommunication routing or the like. It is, therefore, observed that a limited number of solutions to various complex problems are generated before application of genetic algorithm techniques are terminated due to convergence of the population based on the pre-defined fitness criteria.

Further, fitness of each generated solution from the population of solutions is evaluated with respect to the pre-determined fitness function. It has been observed that fitness evaluation provides a fitness score for each solution and based on the fitness score, fitter solutions are selected for the next generation. Furthermore, evaluation of each solution with respect to the fitness function is an expensive process as the computation time is high which increase the overall cost of solution identification process.

In light of the aforementioned drawbacks, there is a need for a system and a method which provides identification of maximum solutions in an n-dimensional search space in a reduced time. There is a need for a system and a method for providing improved performance of evolutionary intelligence techniques for solution identification of complex problems. There is a need for a system and a method for narrowing the n-dimensional search space for fast and maximum solution identification in a finite time. Further, there is a need for a system and a method which provides reduced fitness evaluations. Further, there is a need for a system and a method which provides reduced cost for fitness evaluation of various generated solutions. Furthermore, there is a need for a system and a method for effective and efficient solution identification in an n-dimensional search space with minimum or no human intervention.

### SUMMARY OF THE INVENTION

In various embodiments of the present invention, a method for optimizing solution identification for a problem is provided. The method is implemented by a processor executing instructions stored in a memory. The method comprises generating multiple solutions randomly for the problem by selecting population of one or more datasets from a search space. The method further comprises determining fitness of the each generated solution by utilizing a fitness approximation model for selecting one or more solutions from the generated solutions for generating a next generation of solutions until the solutions converge based on a pre-determined convergence target. The fitness approximation model is created by utilizing one or more seed unproductive solutions. The method further comprises filtering one or more solutions from the converged solutions by utilizing a filtering model for performing a concrete evaluation. The filtering model is created by utilizing one or more seed productive solutions. The concrete evaluation is performed for identifying one or more productive solutions and one or more unproductive solutions from the one or more solutions filtered from the converged solutions. The method further comprises providing a feedback based on the concrete evaluation related to the one or more unproductive solutions and the one or more productive solutions. Finally, the method comprises iteratively repeating steps of generating multiple solutions from a search space, determining fitness of each generated solution until the solutions converge, filtering one or more solutions from the converged solutions for performing a concrete evaluation and providing a feedback based on the concrete evaluation until a termination condition is met.

An optimization system for solution identification for a problem is provided. In various embodiments of the present invention, the system comprises a memory storing program instructions, a processor configured to execute program instructions stored in the memory and a solution identification engine in communication with the processor. The solution identification engine configured to generate multiple solutions randomly for the problem by selecting population of one or more datasets from a search space. The solution identification engine determines fitness of the each generated solution by utilizing a fitness approximation model for selecting one or more solutions from the generated solutions for generating a next generation of solutions until the solutions converge based on a pre-determined convergence target. The fitness approximation model is created by utilizing one or more seed unproductive solutions. The solution identification engine, further, filters one or more solutions from the converged solutions by utilizing a filtering model for performing a concrete evaluation. The filtering model is created by utilizing one or more seed productive solutions. The concrete evaluation is performed for identifying one or more productive solutions and one or more unproductive solutions from the one or more solutions filtered from the converged solutions. The solution identification engine, further, provides a feedback based on the concrete evaluation related to the one or more unproductive solutions and the one or more productive solutions. Finally, the solution identification engine iteratively repeats the steps of generating multiple solutions from a search space, determining fitness of each generated solution until the solutions converge, filtering one or more solutions from the converged solutions for performing a concrete evaluation and providing a feedback based on the concrete evaluation until a termination condition is met.

A computer program product is provided. The computer program product comprises a non-transitory computer-readable medium having computer-readable program code stored thereon, the computer-readable program code comprising instructions that, when executed by a processor, cause the processor to generate multiple solutions randomly for the problem by selecting population of one or more datasets from a search space. Further, fitness of the each generated solution is determined by utilizing a fitness approximation model for selecting one or more solutions from the generated solutions for generating a next generation of solutions until the solutions converge based on a pre-determined convergence target. The fitness approximation model is created by utilizing one or more seed unproductive solutions. Further, one or more solutions from the converged solutions are filtered by utilizing a filtering model for performing a concrete evaluation. The filtering model is created by utilizing one or more seed productive solutions. The concrete evaluation is performed for identifying one or more productive solutions and one or more unproductive solutions from the one or more solutions filtered from the converged solutions. Furthermore, a feedback based on the concrete evaluation related to the one or more unproductive solutions and the one or more productive solutions is provided. Finally, the steps of generating multiple solutions from a search space, determining fitness of each generated solution until the solutions converge, filtering one or more solutions from the converged solutions for performing a concrete evaluation and providing a feedback based on the concrete evaluation are repeated iteratively until a termination condition is met.

### BRIEF DESCRIPTION OF THE ACCOMPANYING DRAWINGS

The present invention is described by way of embodiments illustrated in the accompanying drawings wherein:

FIG. 1 illustrates a detailed block diagram of a system for optimizing multiple discrete solution identification in a search space, in accordance with various embodiments of the present invention;

FIG. 2 is a flowchart illustrating a method for optimizing multiple discrete solution identification in a search space, in accordance with various embodiments of the present invention;

FIG. 2a is a pseudo code illustrating a method for optimizing multiple discrete solution identification in a search space, in accordance with various embodiments of the present invention; and

FIG. 3 illustrates an exemplary computer system in which various embodiments of the present invention may be implemented.

### DETAILED DESCRIPTION OF THE INVENTION

The present invention discloses a system and a method for optimizing multiple discrete solution identification in an n-dimensional search space by employing evolutionary computing techniques iteratively. In particular, the present invention provides for optimizing multiple discrete solution identification for real world complex problems in an n-dimensional search space by iteratively employing evolutionary intelligence techniques and providing a feedback to a next iteration of evolutionary computing technique after every iteration of the evolutionary computing technique. The feedback may comprise evaluated solutions from the previous iterations of the evolutionary intelligence techniques. Further, the present invention provides for generation of one or more new solutions for a complex problem and fitness calculation of each generated solution utilizing a first machine learning model until entire population of solutions reaches a convergence target. Further, the first machine learning model is created utilizing unproductive solutions identified during each iteration of evolutionary intelligence technique. The model utilized provides a reduced cost of evaluation of each generated solution. Further, the present invention provides for filtering of potential solutions from the converged solutions. The solutions are filtered utilizing a second machine learning model. The second machine learning model is created utilizing productive solutions identified during each iteration of evolutionary intelligence techniques. Furthermore, the present invention provides for categorization of potential solutions into, at least, two categories, firstly, into one or more unproductive or failed solutions and secondly, into one or more productive or passed solutions based on a concrete evaluation. Furthermore, based on categorization, the present invention provides for narrowing down the n-dimensional search space for effective and efficient solution optimization and identification in a reduced time.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

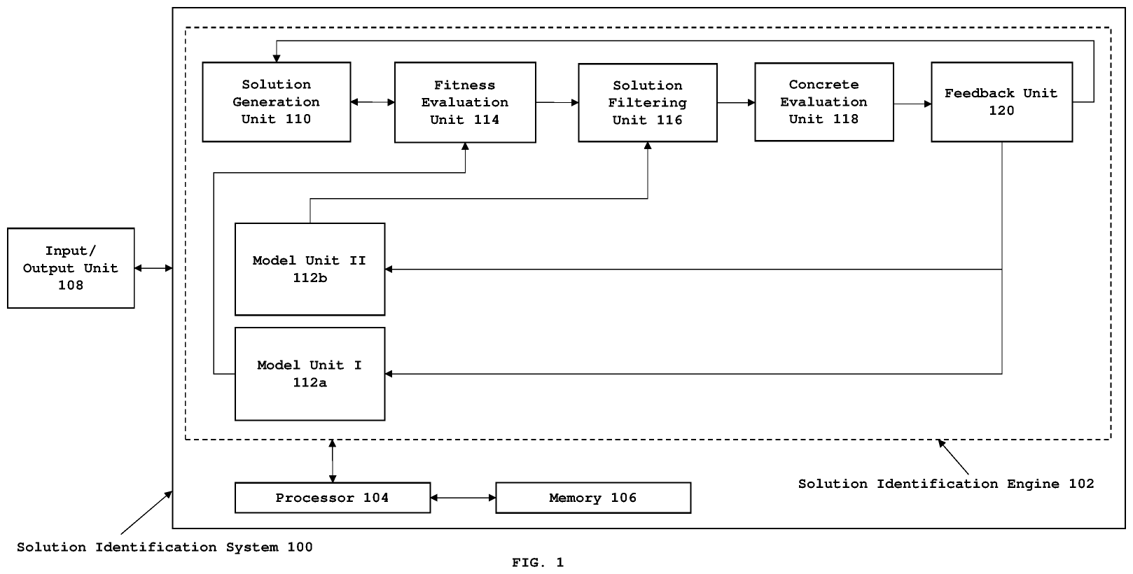

FIG. 1 is a detailed block diagram of a solution identification system 100 for optimizing multiple solution identification in a search space, in accordance with various embodiments of the present invention. The solution identification system 100 is connected to an input/output unit 108 via a communication channel (not shown) for receiving a complex problem for which maximum number of best solutions are to be identified. The communication channel (not shown) may include, but is not limited to, a wire or a logical connection over a multiplexed medium, such as, a radio channel in telecommunications and computer networking. The examples of telecommunications and computer networking may include a local area network (LAN), a metropolitan area network (MAN), a wide area network (WAN) or any wired or wireless network.

The solution identification system 100 comprises a solution identification engine 102, a processor 104 and a memory 106. The solution identification engine 102 is a self-learning and self-optimizing engine configured to automatically identify one or more solutions for one or more complex problems from a large population of potential solutions by reducing the search space for solution identification. The solution identification engine 102 utilizes one or more evolutionary intelligence techniques such as, but are not limited to, genetic algorithm techniques iteratively for solution generation and identification. The solution identification engine 102 has multiple units which work in conjunction with each other for identifying multiple solutions to multiple complex problems in a search space. The various units of the solution identification engine 102 are operated via the processor 104 specifically programmed to execute instructions stored in the memory 106 for executing respective functionalities of the units of the system 100 in accordance with various embodiments of the present invention.

In another embodiment of the present invention, the system 100 may be implemented in a cloud computing architecture in which data, applications, services, and other resources are stored and delivered through shared data-centers. In an exemplary embodiment of the present invention, the functionalities of the system 100 are delivered to a user as software as a service (SaaS) over a communication network.

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server.

In an embodiment of the present invention, the solution identification engine 102 comprises a solution generation unit 110, a model unit I 112a, a model unit II 112b, a fitness evaluation unit 114, a solution filtering unit 116, a concrete evaluation unit 118 and a feedback unit 120.

In an embodiment of the present invention, a search space is provided from which solutions are generated and identified with respect to multiple complex problems. The search space may comprise discrete datasets utilizing which solutions for complex problems are generated and identified. The discrete datasets may be one or more potential solutions to the complex problems. The complex problems may include, but are not limited to, functional test data generation for a software application, optimizing the proportional-integral-derivative (PID) controller parameters for quadcopter (drone) flight motion, game playing agents, vehicle routing, multiple object optimization, telecommunication routing or the like. In an exemplary embodiment of the present invention, search space is utilized for generating and identifying solutions from discrete datasets for a particular type of complex problem. The discrete datasets may include data with respect to the complex problems, but are not limited to, functional test data for a software application, optimization data for the proportional-integral-derivative (PID) controller parameters for quadcopter (drone) flight motion, game playing agents data, vehicle routing solution data, multiple object optimization solution data, telecommunication routing solution data or the like. The discrete datasets may exist in the search space in a random manner. Further, the search space is capable of being configured for providing various discrete datasets for solution generation and identification to multiple complex problems.

The discrete datasets present in the search space may be composed of one or more attributes. For example, if the dataset relates to an employee object data, the attributes attached may include, but are not limited to, age, years of service, gender of employee, employment status or the like. The attributes may be categorized into at least, two types: firstly, a continuous attribute and secondly, a categorical attribute. The continuous attribute provides a data value which can be expressed from a range of bounded parameters. For example, the continuous attribute attached to the solution relating to employee object data may have age as 50 years old selected from a range of values from 0 to 100 or years of service as 25 years selected from a range of values from 0 to 40 or the like. Further, the categorical attribute provides a data value which can be expressed with a single parameter from a set of given parameters. For example, gender of an employee may either be a male or a female from a given set of parameters of male and female or the employment status of an employee may either be full time, part time or temporary from a set of full time, part time or temporary parameters or the like. Similarly, multiple solutions in the population of solutions with respect to other problem types may be associated with different one or more attribute types.

In an embodiment of the present invention, the engine 102 is configured to create two machine learning models based on unproductive and productive solutions respectively and subsequently train the created two models after each iteration of the evolutionary computing technique. The two models created comprises a fitness approximation model and a filtering model. The fitness approximation model is created based on seed unproductive solutions and trained based on a cumulative set or cluster of unproductive or failed solutions after an iteration of evolutionary computing technique. Further, the filtering model is created based on seed productive solutions and trained based on a cumulative set or cluster of productive or passed solutions after an iteration of evolutionary computing technique. The fitness approximation model and the filtering model are created by utilizing machine learning techniques such as, but are not limited to, artificial neural networks (ANN) or the like. The created and trained fitness approximation model and the filtering model are adversarial in nature.

In an exemplary embodiment of the present invention, the solution identification engine 102 is configured to initially create the fitness approximation model based on a set of seed unproductive solutions in the model unit I 112a. The creation of the fitness approximation model with the seed unproductive solutions is based on inputting of continuous attributes and the categorical attributes. Further, the fitness approximation model is created by adding one or more dummy attributes into the solution for each value of each categorical attribute in a column form with 1 or 0 as values based on the actual value of attribute in the solution. The dummy attributes with their appropriate values are individually scaled by applying scaling techniques such as, but are not limited to, standard scaler or the like. After the attribute values are scaled, the model unit I 112a is configured to apply multiple unsupervised clustering techniques to form a cluster or group of similar seed solutions which may comprise seed unproductive solutions. The unsupervised clustering techniques applied may include, but are not limited to, K-means, meanshift, density-based spatial clustering (DBSCAN), hierarchical density-based spatial clustering (HDBSCAN) or the like. The multiple unsupervised clustering techniques are applied in parallel. After clustering or grouping of similar solutions, each single solution in the cluster or group is assessed for its similarity with its cluster or group as compared to other clusters or groups. The technique applied by the model unit I 112a for assessing the similarity may include, but is not limited to, silhouette score technique or the like. The clusters with high silhouette score are selected for fitness approximation model creation. The fitness approximation model created is an artificial neural network based model. After the solutions are clustered, each cluster of solutions is labelled and are utilized for training the created fitness approximation model. The fitness approximation model is created to be trained with only unproductive or failed solutions. The trained artificial neural network based fitness approximation model is thereafter saved in a model storage database (not shown).

Further, in another exemplary embodiment of the present invention, the solution identification engine 102 is configured to create the filtering model based on a set of seed productive solutions in the model unit II 112b. The creation of the filtering model with the productive solutions is based on inputting of the continuous attributes and the categorical attributes. Further, the filtering model is created by adding one or more dummy attributes into the solution for each value of each categorical attribute in a column form with 1 or 0 as values based on the actual value of attribute in the solution. The dummy attributes with their appropriate values are individually scaled by applying scaling techniques such as, but are not limited to, standard scaler or the like. After the attribute values are scaled, the model unit II 112b is configured to apply unsupervised clustering techniques to form a cluster or group of similar productive solutions. The unsupervised clustering techniques applied may include, but are not limited to, K-means, meanshift, density-based spatial clustering (DBSCAN), hierarchical density-based spatial clustering (HDBSCAN) or the like. After clustering or grouping of similar solutions, each single solution in the cluster or group is assessed for its similarity with its cluster or group as compared to other clusters or groups. The technique applied by the model unit II 112b for assessing the similarity may include, but is not limited to, silhouette score technique or the like. The clusters with high silhouette score are selected for filtering model creation. The filtering model created is an artificial neural network based model. After the solutions are clustered, each cluster of solutions is labelled and are utilized for training the created filtering model. The filtering model is created to be trained with productive or passed solutions. The trained artificial neural network based filtering model is thereafter saved in the model storage database (not shown).

In operation, in an embodiment of the present invention, the solution generation unit 110 is configured to randomly generate an initial population of solutions by selecting a population of discrete datasets from the search space when a problem is received by the system 100 via the input/output unit 108. The solution generation unit 110 is configured to generate one or more new solutions for the received problem by utilizing evolutionary intelligence techniques such as, but are not limited to, genetic algorithm techniques or the like. The genetic algorithm techniques applied utilizes processes analogous to biological processes of evolution to generate an initial population of solutions from existing population of datasets. The genetic algorithm techniques apply biological processes on randomly selected datasets for solution generation. The initial population of solutions is generated based on attribute types of the discrete datasets present in the search space.

The solution generation process is initiated by the solution generation unit 110 by randomly generating new population of solutions from the search space. The randomly generated solutions are referred to as chromosomes. Further, chromosomes are formed of array of genes. Further, the genes are analogous to attributes of a solution. The selected population of datasets are subjected to multipoint crossover and mutation processes for generation of new solutions from the datasets present in the search space. The attribute values associated with the solution may be varied by the solution generation unit 110. The values associated with the continuous attribute may not vary beyond the maximum and minimum permissible values. Further, values associated with the categorical attribute may comprise only one value at a time from the set of permissible parameters.

In an embodiment of the present invention, the fitness evaluation unit 114 is configured to receive the newly generated solutions from the solution generation unit 110. The newly generated solutions are received for determining fitness of each newly generated solution. The fitness of each new solution is determined for selecting the fit solutions for generating next generation of solutions. The fitness evaluation unit 114 invokes the model unit I 112a for fetching the trained and stored fitness approximation model from model storage database (not shown) for utilizing in determining fitness of each newly generated solution which is to be selected for next generation. The fitness approximation model determines whether the generated solution belongs to a cluster of known unproductive solutions. Firstly, probability of the generated new solutions is determined as whether a particular solution belongs to a known cluster of unproductive solutions or not. The fitness approximation model is configured to determine the fitness score after calculating a probability score of a solution. Further, the fitness score is a probability of a solution belonging to a known cluster of unproductive solutions. The probability score is in the range of 0 to 1. Therefore, each generated solution is evaluated for determining the probability score which provides probability of the solution relating to the cluster of unproductive solutions. Therefore, if the probability score of a solution is higher with respect to probability score of other generated solutions, the solution is considered to be similar to the cluster of unproductive solutions and is not utilized in generating next generation of new solutions. In contrast, if the probability score of a solution is lower with respect to probability score of other generated solutions, the solution is considered to be a fit solution and is utilized in generating next generation of new solutions. Further, if the probability score of all the generated solutions is very low, then the solution is considered to be a productive solution and does not belong to the known cluster of unproductive solutions.

Secondly, after determining the probability score for each solution with respect to the cluster of unproductive solutions the probability score is inverted by the fitness evaluation unit 114 for calculating the fitness score of each newly generated solution. The probability score is inverted by subtracting the calculated probability score from 1, i.e. (1-probability score) for calculating the fitness score of the new generated solution. The solution generation unit 110 utilizes the calculated fitness score for selecting the solutions from previous generations for generating next generation of new solutions. The solutions with highest fitness score are selected for next generation of solutions.

Further, the fitness evaluation unit 114 is configured to communicate with the solution generation unit 110 after fitness score calculation to provide the calculated probability score calculation and fitness score of solutions such that the solutions with high fitness score which are considered to be fit solutions are utilized by the solution generation unit 110 for subsequently generating next generation of new solutions. The solution generation unit 110 is configured to apply genetic algorithm techniques on the fit solutions from the previous generations for generating next generation of new solutions. Further, the solution generation unit 110 utilizes a lesser number of solutions for generating next generation of new solutions as the unproductive solutions from the previous generations are rejected. The generation of new solutions by the solution generation unit 110 continues until a convergence condition is reached and maximum number of solutions in the previous generation are replaced with new generation of fit solutions. The population convergence condition may include, but is not limited to, pre-determining a convergence target or the like. Therefore, further generation of new solutions is terminated by the solution generation unit 110 when the pre-determined convergence target reaches a configurable threshold value i.e. the solutions are said to have converged and further generation of new solutions is terminated by the solution generation unit 110.

In an embodiment of present invention, the solution filtering unit 116 is configured to receive the converged solutions from the solution generation unit 110 via the fitness evaluation unit 114. The converged solutions in the converged population of solutions are received by the solution filtering unit 116 for subsequent evaluation and filtering. The converged solutions received by the solution filtering unit 116 comprises solutions which have increased level of fitness as compared to the previously generated solutions. The solution filtering unit 116 invokes the model unit II 112b for fetching the stored filtering model from model storage database (not shown) for evaluating and filtering each converged solution. The filtering model is trained with productive solutions and evaluates and filters the newly generated solutions in a probabilistic manner. The filtering model is configured to determine a probability score of a converged solution. The probability score is in the range of 0 to 1. The probability score of a solution calculated by the filtering model determines whether the particular converged solution belongs to the known cluster of productive solutions. Therefore, each converged solution is evaluated for determining the probability score which provides probability of each converged solution as relating to the cluster of known productive solutions. The probability score of the generated new solutions belonging to the cluster of known productive solutions is assessed with respect to a pre-determined probability limit. The pre-determined probability limit signifies a value above which no potential solution may exist and below which one or more potential solutions may exist. Therefore, if the probability score of the converged solution is higher than a pre-determined probability limit, the converged solution is marked as similar to the cluster of productive solutions and the solution filtering unit 116 is configured to reject such solutions as there is a greater possibility of such solution becoming redundant. For example, the filtering model is created using already identified productive solutions i.e. solutions which meets the problem objective. Further, the generated solution is evaluated by the filtering model for determining the probability of such generated solution as belonging to the cluster of productive solutions. Therefore, if the probability is higher than the pre-determined probability limit, it signifies that the solution has already been arrived for the problem in an earlier iteration of solution generation and is marked as redundant and is filtered out. In contrast, if the probability score of the solution is lower than the pre-determined probability limit, the converged solution is considered to be distinct from the already existing productive solutions and is marked as a potential solution for the problem as compared to other converged solutions. Therefore, the potential solutions from the population of converged solutions are filtered from the unfit solutions.

In an embodiment of the present invention, the concrete evaluation unit 118 is configured to receive the potential solutions from the solution filtering unit 116, filtered from the converged solutions. Further, the concrete evaluation unit 118 is configured to identify the fittest solution by evaluating and verifying the effectiveness of the received potential solutions in solving the complex problem. The concrete evaluation unit 118 is configured to firstly, divide potential solutions utilizing data division techniques such as but are not limited to, bucketing or the like. The solutions are divided into multiple buckets based on a configurable parameter. For example, if a bucket size is 25 and 50 solutions are to be evaluated with respect to the fitness function, then 25 buckets, each containing two solutions, are created. Therefore, each bucket contains multiple potential solutions.

Further, after the buckets are created, the concrete evaluation unit 118 is configured to secondly, determine whether each potential solution in the bucket is a productive solution or an unproductive solution with respect to the certain objective for solving the complex problem. The determination of solution as productive or unproductive, whether capable of solving the complex problem, is carried out by executing multiple threads in parallel for each solution in each bucket. In an exemplary embodiment of the present invention, entire bucket of potential solutions is considered as productive, if a single solution in the bucket of potential solutions is determined as productive. Further, the entire bucket of potential solutions is considered as unproductive, if none of the single solution in the bucket of potential solutions is determined as productive. For instance, each thread executes concrete evaluation on each bucket for each potential solution present in the bucket. Therefore, if solution satisfies a concrete evaluation criteria, the potential solutions in the bucket are considered as productive or else unproductive. For example, if maximum number of solutions have to be determined for a computer application testing scenarios, then evaluation of the converged solutions with respect to the concrete evaluation criteria may relate to concrete execution of target functionality to evaluate that the target functionality covers a new branch. Therefore, if it covers a new branch, the potential solution is considered to be a productive solution or else an unproductive solution.

In an embodiment of the present invention, the feedback unit 120 is configured to receive the identified buckets of productive and unproductive solutions from the concrete evaluation unit 118 and communicate the buckets of unproductive solutions as a feedback to the solution generation unit 110 for reducing the search space for solution generation and providing the feed backed unproductive solutions from the solution generation unit 110 to the model unit I 112a via the fitness evaluation unit 114 for re-creating the fitness approximation model. Further, the feedback unit 120 may communicate the buckets of productive solutions as a feedback to the solution filtering unit 116 for extending its evaluation space for effective solution filtering and providing the feed backed productive solutions from the solution filtering unit 116 to the model unit II 112b for re-creating the filtering model.

In another embodiment of the present invention, the feedback unit 120 is configured to communicate the buckets of unproductive solutions received from the concrete evaluation unit 118 to the model unit I 112a for training the fitness approximation model. Further, the feedback unit 120 is configured to communicate the buckets of productive solutions received from the concrete evaluation unit 118 to the model unit II 112b for training the filtering model.

In an embodiment of the present invention, the filtering model is re-created and trained in the model unit II 112b with buckets of productive solutions received from the solution filtering unit 116 and the feedback unit 120 respectively. The model unit II 112b is configured to apply unsupervised clustering techniques on bucket of productive solutions cumulatively to form a cluster or group of productive solutions. The unsupervised clustering techniques applied may include, but are not limited to, meanshift, density-based spatial clustering (DBSCAN), hierarchical density-based spatial clustering (HDBSCAN) or the like. For instance, when a meanshift clustering technique is applied, four sample size may be utilized. The sample size may include, but are not limited to, 20, 24, 28 and 36. After the sample sizes are selected, clusters are formed for each sample size by repeatedly applying unsupervised clustering techniques on each sample size. Further, after clusters for each sample size are formed, the model unit II 112b is configured to calculate a similarity score by applying techniques such as, but are not limited to, silhouette score or the like. A silhouette score is calculated for each cluster of each sample size. Similarly, if a DBSCAN technique is utilized, a silhouette score is calculated for each cluster. Further, the cluster with maximum silhouette score is selected and labelled. Therefore, the selected cluster and cluster label are utilized to -train the filtering model. The model unit II 112b is configured to apply one or more activation function for training the filtering model. The activation function applied may include, but is not limited to, rectified linear unit (ReLU) activation function or the like. Further, after the filtering model is trained, training and validation loss for each epoch is calculated. Further, if the loss is below a pre-determined reference value, the re-trained filtering model is not saved in the model storage database (not shown). The epoch loss indicates overfitting of solutions in the filtering model. Further, the model unit II 112b is configured to restrict the overfitting of solutions in the filtering model. The overfitting of solutions is restricted by, at least, describing an early stop condition which stops training of the filtering model when the epoch loss is below the pre-determined reference value or adding a dropout layer in the filtering model. The stored filtering model is thereafter utilized in a next iteration of new solution identification to filter out the similar productive solutions.

In an embodiment of the present invention, the fitness approximation model is re-created and trained in the model unit I 112a from the received buckets of unproductive solutions received from the solution generation unit 110 via the fitness evaluation unit 114 and the feedback unit 120 respectively. The model unit I 112a is configured to apply unsupervised clustering techniques on buckets of unproductive solutions cumulatively to form a cluster or group of unproductive solutions. The unsupervised clustering techniques applied may include, but are not limited to, meanshift, density-based spatial clustering (DBSCAN), hierarchical density-based spatial clustering (HDBSCAN) or the like. For instance, when a meanshift clustering technique is applied, four sample size may be utilized. The sample size may include, but are not limited to, 20, 24, 28 and 36. After the sample sizes are selected, clusters are formed for each sample size by repeatedly applying unsupervised clustering techniques on each sample size. Further, after clusters for each sample size are formed, the model unit I 112a is configured to calculate a similarity score by applying techniques such as, but are not limited to, silhouette score or the like. A silhouette score is calculated for each cluster of each sample size. Similarly, if a DBSCAN technique is utilized, a silhouette score is calculated for each cluster. Further, the cluster with maximum silhouette score is selected and labelled. Therefore, the selected cluster and cluster label are utilized to train the fitness approximation model. The model unit I 112a is configured to apply one or more activation functions for training the fitness approximation model. The activation functions applied may include, but is not limited to, rectified linear unit (ReLU) activation function or the like. Further, after the fitness approximation model is trained, the training and validation loss for each epoch is calculated. Further, if the loss is below a pre-determined reference value, the trained model is not saved in the model storage database (not shown). The epoch loss indicates overfitting of solutions in the fitness approximation model. Further, the model unit I 112a is configured to restrict the overfitting of solutions in the fitness approximation model. The overfitting of solutions is restricted by, at least, describing an early stop condition which stops training of the fitness approximation model when the epoch loss is below the pre-determined reference value or adding a dropout layer in the fitness approximation model. Lastly, the trained model is saved, if the calculated training and validation loss for each epoch is found to be above the pre-determined reference value. The stored fitness approximation model is thereafter utilized in a next iteration of new solution generation and identification to filter out the unproductive solutions.

In an embodiment of the present invention, the solution identification engine 102 is configured to further invoke the solution generation unit 110 for execution of next iteration of evolution for solution generation and identification after the fitness approximation model and filtering model are re-created and trained. Further, first iteration of solution generation and identification by the engine 102 comprises steps of: new generation of population is generated; the fitness of the generated new population is evaluated until the convergence target is reached; solutions are filtered; concrete evaluation is carried out; and the fitness approximation model and filtering model are re-created. The solution identification engine 102 starts the next iteration for solution generation and identification comprising steps of: invoking the solution generation unit 110 for generation and evolution of converged solutions until further converge by calculating fitness of each generated solution before convergence; converged solutions are filtered; filtered solutions are concretely evaluated and a feedback of concrete evaluation is provided for re-creating and training fitness approximation model and filtering model and for next iteration of evolution process. Further, the solution generation unit 110 is configured to generate new population of solutions from reduced search space as the unproductive solutions are identified in the previous iterations. Therefore, from subsequent iterations of evolution the unproductive solutions are identified and rejected, thereby providing reduced search space for the solution generation unit 110. The subsequent iterations of evolutions are carried out by the solution identification engine 102 until a termination condition is met. The termination condition is met when configurable number of solutions associated with the complex problem are identified.

Advantageously, in accordance with various embodiments of the present invention, the system 100 is configured with built-in intelligence mechanism which is capable of automatically optimizing identification of multiple solutions in an n-dimensional search space by employing iterative evolutionary computing techniques. The system 100 provides for an iterative application of evolutionary intelligence techniques such as genetic algorithm techniques, for improved solution generation and identification by providing feedback from the previous iterations for generation of solutions. Further, the system 100 provides for an improved fitness approximation technique in subsequent iterations for evaluating fitness of the generated solutions utilizing two artificial neural network based adversarial systems before evaluating the generated solutions for concrete evaluation, thereby minimizing the overall computing time and cost. Further, the system 100 is capable of identifying patterns of failed or unproductive solutions thereby, avoiding further generation of solutions from unproductive solutions. Further, the system 100, at the end of an iteration during the iterative evolutionary process, is capable of training the fitness approximation model with cumulative set of solutions that were identified as unproductive after the concrete evaluation and train the filtering model with cumulative set of solutions that were identified as productive after the concrete evaluation. Furthermore, the system 100 is capable of automatically recognizing most effective regions in the n-dimensional search space of potential solutions and intelligently synthesis maximum new solutions in a reduced time with minimum human intervention.

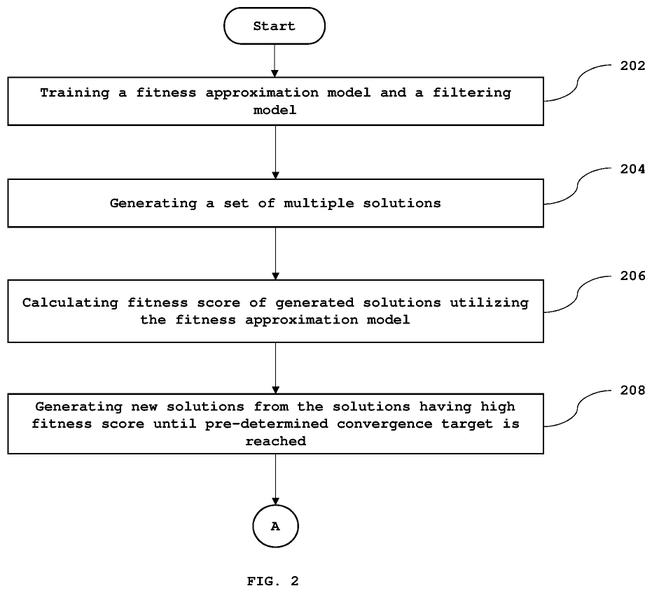

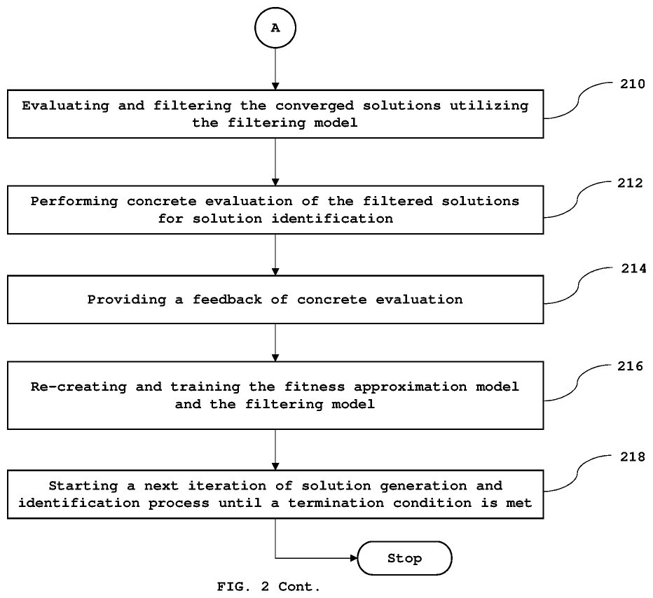

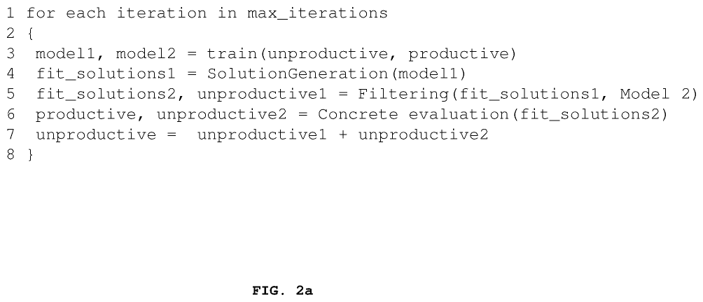

FIG.2 is a flowchart illustrating a method for optimizing multiple discrete solution identification in a search space, in accordance with various embodiments of the present invention. FIG. 2a illustrates an exemplary pseudo code for implementing the method for optimizing multiple discrete solution identification in a search space, in accordance with various embodiments of the present invention.

At step 202, a fitness approximation model and a filtering model is trained. In an embodiment of the present invention, the fitness approximation model is created based on seed unproductive solutions and the filtering model is created based on seed productive solutions and the two models are subsequently trained after each iteration of the evolutionary computing technique. The two models are created by utilizing machine learning techniques such as, but are not limited to, artificial neural networks (ANN) or the like. The created and trained fitness approximation model and the filtering model are adversarial in nature.

Further, a search space is provided from which solutions are generated and identified with respect to multiple complex problems. The search space may comprise discrete datasets utilizing which solutions for the complex problem are generated and identified. The discrete datasets may be one or more potential solutions to the complex problems. The complex problems may include, but are not limited to, functional test data generation for a software application, optimizing the proportional-integral-derivative (PID) controller parameters for quadcopter (drone) flight motion, game playing agents, vehicle routing, multiple object optimization, telecommunication routing or the like. In an exemplary embodiment of the present invention, search space is utilized for generating and identifying solutions from discrete datasets for a particular type of complex problem. The discrete datasets may include data with respect to the complex problems, but are not limited to, functional test data for a software application, optimization data for the proportional-integral-derivative (PID) controller parameters for quadcopter (drone) flight motion, game playing agents data, vehicle routing solution data, multiple object optimization solution data, telecommunication routing solution data or the like. The discrete datasets may exist in the search space in a random manner. Further, the search space is capable of being configured for providing various discrete datasets for solution generation and identification to multiple complex problems.

Further, the discrete datasets present in the search space are composed of one or more attributes. For example, if the solution relates to an employee object data, the attributes attached may include, but are not limited to, age, years of service, gender of employee, employment status or the like. The attributes may be categorized into at least, two types: firstly, a continuous attribute and secondly, a categorical attribute. The continuous attribute provides a data value which can be expressed from a range of bounded parameters. For example, the continuous attribute attached to the solution relating to employee object data may have age as 50 years old selected from a range of values from 0 to 100 or years of service as 25 years selected from a range of values from 0 to 40 or the like. Further, the categorical attribute provides a data value which can be expressed by a single parameter from a set of given parameters. For example, gender of an employee may either be a male or a female from a given set of parameters of male and female or the employment status of an employee may either be full time, part time or temporary from a set of full time, part time or temporary parameters or the like. Similarly, multiple solutions in the population of solutions with respect to other problem types may be associated with different one or more attribute types.

In an exemplary embodiment of the present invention, the fitness approximation model is initially created based on a set of seed unproductive solutions. The creation of the fitness approximation model with the seed unproductive solutions is based on inputting of continuous attributes and the categorical attributes. Further, the fitness approximation model is created by adding one or more as dummy attributes into the solution for each value of each categorical attribute in a column form with 1 or 0 as values based on the actual value of attribute in the solution. The dummy attributes with their appropriate values are individually scaled by applying scaling techniques such as, but are not limited to, standard scaler or the like. After the attribute values are scaled, multiple unsupervised clustering techniques are applied to form a cluster or group of similar seed solutions which may comprise seed unproductive solutions. The unsupervised clustering techniques applied may include, but are not limited to, K-means, meanshift, density-based spatial clustering (DBSCAN), hierarchical density-based spatial clustering (HDBSCAN) or the like. The multiple unsupervised clustering techniques are applied in parallel. After clustering or grouping of similar solutions, each single solution in the cluster or group is assessed for its similarity with its cluster or group as compared to other clusters or groups. The technique for assessing the similarity may include, but is not limited to, silhouette score technique or the like. The clusters with high silhouette score are selected for fitness approximation model creation. The fitness approximation model created is an artificial neural network based model. After the solutions are clustered, each cluster of solutions is labelled and are utilized for training the created fitness approximation model. The fitness approximation model is created to be trained with only unproductive or failed solutions. The trained artificial neural network based fitness approximation model is thereafter saved in a model storage database (not shown).

Further, in another exemplary embodiment of the present invention, the filtering model is created based on a set of seed productive solutions. The creation of the filtering model with the productive solutions is based on inputting of the continuous attributes and the categorical attributes. Further, the filtering model is created by adding one or more dummy attributes into the solution for each value of each categorical attribute in a column form with 1 or 0 as values based on the actual value of attribute in the solution. The dummy attributes with their appropriate values are individually scaled by applying scaling techniques such as, but are not limited to, standard scaler or the like. After the attribute values are scaled, unsupervised clustering techniques are applied to form a cluster or group of similar productive solutions. The unsupervised clustering techniques applied may include, but are not limited to, K-means, meanshift, density-based spatial clustering (DBSCAN), hierarchical density-based spatial clustering (HDBSCAN) or the like. After clustering or grouping of similar solutions, each single solution in the cluster or group is assessed for its similarity with its cluster or group as compared to other clusters or groups. The technique applied for assessing the similarity may include, but is not limited to, silhouette score technique or the like. The clusters with high silhouette score are selected for filtering model creation. The filtering model created is an artificial neural network based model. After the solutions are clustered, each cluster of solutions is labelled and are utilized for training the created filtering model. The filtering model is created to be trained with productive or passed solutions. The trained artificial neural network based filtering model is thereafter saved in the model storage database (not shown).

At step 204, a set of multiple solutions are generated. In an embodiment of the present invention, the generated solutions are an initial population of generated solutions which are generated randomly by selecting a population of discrete datasets from the search space when a problem is received. The problem received is a problem for which new solutions are to be identified. The generation of set of new solutions for the received problem is carried out by utilizing evolutionary intelligence techniques such as, but are not limited to, genetic algorithm techniques or the like. The genetic algorithm techniques applied utilizes processes analogous to biological processes of evolution to generate an initial population of solutions from existing population of datasets. The genetic algorithm techniques apply biological processes on randomly selected datasets for solution generation. The initial population of solutions is generated based on attribute types of the discrete datasets present in the search space.

The solution generation process is initiated by randomly generating new population of solutions from the search space. The randomly generated solutions are referred to as chromosomes. Further, chromosomes are formed of an array of genes. Further, the genes are analogous to attributes of a solution. The selected population of datasets are subjected to multipoint crossover and mutation processes for generation of new solutions from the datasets present in the search space. The attribute values associated with the solution may be varied. The values associated with the continuous attribute may not vary beyond the maximum and minimum permissible values. Further, values associated with the categorical attribute may comprise only one value at a time from the set of permissible parameters.

At step 206, fitness score of generated solutions is calculated utilizing the fitness approximation model. In an embodiment of the present invention, the newly generated solutions are subjected for determining fitness of each new generated solution. The fitness of each new solution is determined for selecting the fit solutions for generating next generation of solutions. The trained and stored fitness approximation model is fetched to be utilized in determining fitness of each newly generated solution which is to be selected for next generation. The fitness approximation model determines whether the generated solution belongs to a cluster of known unproductive solutions. Firstly, probability of the generated new solutions is determined as whether a particular solution belongs to a known cluster of unproductive solutions or not. The fitness approximation model is configured to determine the fitness score after calculating the probability score of a solution. Further, the fitness score is a probability of a solution belonging to a known cluster of unproductive solutions. The probability score is in the range of 0 to 1. Therefore, each generated solution is evaluated for determining the probability score which provides probability of the solution relating to the cluster of unproductive solutions. Therefore, if the probability score of a solution is higher with respect to probability score of other generated solutions, the solution is considered to be similar to the cluster of unproductive solutions and is not utilized in generating next generation of new solutions. In contrast, if the probability score of a solution is lower with respect to probability score of other generated solutions, the solution is considered to be a fit solution and is utilized in generating next generation of new solutions. Further, if the probability score of all the generated solutions is very low, then the solution is considered to be a productive solution and does not belong to the known cluster of unproductive solutions.

Secondly, after determining the probability score for each solution with respect to the cluster of unproductive solutions the probability score is inverted for calculating the fitness score of each newly generated solution. The probability score is inverted by subtracting the calculated probability score from 1, i.e. (1-probability score) for calculating the fitness score of the new generated solution. The calculated fitness score is utilized for selecting the solutions from previous generations for generating next generation of new solutions. The solutions with highest fitness score are selected for next generation of solutions.

At step 208, new solutions are generated from the solutions having high fitness score until pre-determined convergence target is reached. In an embodiment of the present invention, solutions high fitness score which are considered to be fit solutions are utilized for subsequently generating next generation of new solutions. Further, genetic algorithm techniques are applied on the fit solutions from the previous generations for generating next generation of new solutions. Further, a lesser number of solutions is utilized for generating next generation of new solutions as the unproductive solutions from the previous generations are rejected. The generation of new solutions continues until a convergence condition is reached and maximum number of solutions in the previous generation are replaced with new generation of fit solutions. The population convergence condition may include, but is not limited to, pre-determining a convergence target or the like. Therefore, when the pre-determined convergence target reaches a configurable threshold value i.e. the solutions are said to have converged and further generation of new solutions is terminated.

At step 210, converged solutions are evaluated and filtered utilizing the filtering model. In an embodiment of the present invention, the converged solutions are subjected to subsequent evaluation and filtering. The converged solutions comprises solutions which have increased level of fitness as compared to the previously generated solutions. The filtering model is fetched for evaluating and filtering each converged solution. The filtering model is trained with productive solutions and evaluates and filters the newly generated solutions in a probabilistic manner. The filtering model is configured to determine a probability score of a converged solution. The probability score is in the range of 0 to 1. The probability score of a solution calculated by filtering model determines whether the particular converged solution belongs to known cluster of productive solutions. Therefore, each converged solution is evaluated for determining the probability score which provides probability of each converged solution as relating to the cluster of known productive solutions. The probability score of the generated new solutions belonging to the known cluster of productive solutions is assessed with respect to a pre-determined probability limit. The pre-determined probability limit signifies a value above which no potential solution may exist and below which potential solutions may exist. Therefore, if the probability score of the converged solution is higher than a pre-determined probability limit, the converged solution is marked as similar to the cluster of productive solutions and is rejected as there is a greater possibility of such solution becoming redundant. For example, the filtering model is created using already identified productive solutions i.e. solutions which meets the problem objective. Further, the generated solution is evaluated by the filtering model for determining the probability of such generated solution as belonging to the cluster of productive solutions. Therefore, if the probability is higher than the pre-determined probability limit, it signifies that the solution has already been arrived for the problem in an earlier iteration of solution generation and is marked as redundant and is filtered out. In contrast, if the probability score of the solution is lower than the pre-determined probability limit, the converged solution is considered to be distinct from the already existing productive solutions and is considered as a potential solution for the problem as compared to other converged solutions. Therefore, the potential solutions from the population of converged solutions are filtered from the unfit solutions.

At step 212, concrete evaluation of the filtered solutions is performed for solution identification. In an embodiment of the present invention, the potential solutions filtered from the converged solutions are evaluated for performing concrete evaluation. The fittest solution is identified by evaluating and verifying the effectiveness of the received potential solutions in solving the complex problem. Firstly, potential solutions are divided utilizing data division techniques such as but are not limited to, bucketing or the like. The solutions are divided into multiple buckets based on a configurable parameter. For example, if a bucket size is 25 and 50 solutions are to be evaluated with respect to the fitness function, then 25 buckets, each containing 2 solutions, are created. Therefore, each bucket contains multiple potential solutions.

Further, after the buckets are created, secondly, it is determined whether each potential solution in the bucket is a productive solution or an unproductive solution with respect to the certain objective for solving the complex problem. The determination of solution as productive or unproductive, whether capable of solving the complex problem, is carried out by executing multiple threads in parallel for each solution in each bucket. In an exemplary embodiment of the present invention, entire bucket of potential solutions is considered as productive, if a single solution in the bucket of potential solutions is determined as productive. Further, the entire bucket of potential solutions is considered as unproductive, if none of the single solution in the bucket of potential solutions is determined as productive. For instance, each thread executes concrete evaluation on each bucket for each potential solution present in the bucket. Therefore, if solution satisfies a concrete evaluation criteria, the potential solutions in the bucket are considered as productive or else unproductive. For example, if maximum number of solutions have to be determined for a computer application testing scenarios, then evaluation of the converged solutions with respect to the concrete evaluation criteria may relate to concrete execution of target functionality to evaluate that the target functionality covers a new branch. Therefore, if it covers a new branch, the potential solution is considered to be a productive solution or else an unproductive solution.

At step 214, a feedback of concrete evaluation is provided. In an embodiment of the present invention, the feedback is provided for solution generation and solution evaluation and filtering the converged solutions. The identified buckets of productive and unproductive solutions are received. The buckets of unproductive solutions are communicated as a feedback for solution generation for reducing the search space for solution generation and providing the feed backed unproductive solutions for re-creating the fitness approximation model. Further, the buckets of productive solutions may be communicated as a feedback for extending the solution evaluation space for effective solution filtering and providing the feed backed productive solutions for re-creating the filtering model.

In another embodiment of the present invention, the buckets of unproductive solutions are communicated for training the fitness approximation model. Further, the buckets of productive solutions are communicated for training the filtering model.

At step 216, the fitness approximation model and the filtering model are re-created and trained. In an embodiment of the present invention, the identified buckets of productive solutions and unproductive solutions are utilized as re-creation and training data for the filtering model and fitness approximation model respectively.

In an embodiment of the present invention, filtering model is re-created and trained with buckets of productive solutions. Further, unsupervised clustering techniques are applied on bucket of productive solutions cumulatively to form a cluster or group of productive solutions. The unsupervised clustering techniques applied may include, but are not limited to, meanshift, density-based spatial clustering (DBSCAN), hierarchical density-based spatial clustering (HDBSCAN) or the like. For instance, when a meanshift clustering technique is applied, four sample size may be utilized. The sample size may include, but are not limited to, 20, 24, 28 and 36. After the sample size are selected, thereafter, clusters are formed for each sample size by repeatedly applying unsupervised clustering techniques on each sample size. Further, after clusters for each sample size are formed, a similarity score is calculated by applying techniques such as, but are not limited to, silhouette score or the like. A silhouette score is calculated for each cluster of each sample size. Similarly, if a DBSCAN technique is utilized, a silhouette score is calculated for each cluster. Further, the cluster with maximum silhouette score is selected and labelled. Therefore, the selected cluster and cluster label are utilized to re-train the filtering model. Further, one or more activation function are applied for re-training the filtering model. The activation function applied may include, but is not limited to, rectified linear unit (ReLU) activation function or the like. Further, after the filtering model is trained, the training and validation loss for each epoch is calculated. Further, if the loss is below a pre-determined reference value, the re-trained filtering model is not saved in the model storage database (not shown). The epoch loss indicates overfitting of solutions in the filtering model. Further, overfitting of solutions may be restricted in the filtering model. The overfitting of solutions is restricted by, at least, describing an early stop condition which stops training of the filtering model when the epoch loss is below the pre-determined reference value or adding a dropout layer in the filtering model. The stored filtering model is thereafter utilized in a next iteration of new solution generation and identification to filter out the similar productive solutions.

In an embodiment of the present invention, the fitness approximation model is re-created and trained with the received bucket of unproductive solutions. The unsupervised clustering techniques are applied on the bucket of unproductive solutions cumulatively to form a cluster or group of unproductive solutions. The unsupervised clustering techniques applied may include, but are not limited to, meanshift, density-based spatial clustering (DBSCAN), hierarchical density-based spatial clustering (HDBSCAN) or the like. For instance, when a meanshift clustering technique is applied, four sample sizes may be utilized. The sample sizes may include, but are not limited to, 20, 24, 28 and 36. After the sample sizes are selected, thereafter, clusters are formed for each sample size by repeatedly applying unsupervised clustering techniques on each sample size. Further, after clusters for each sample size are formed, a similarity score is calculate by applying techniques such as, but are not limited to, silhouette score or the like. A silhouette score is calculated for each cluster of each sample size. Similarly, if a DBSCAN technique is utilized, a silhouette score is calculated for each cluster. Further, the cluster with maximum silhouette score is selected and labelled. Therefore, the selected cluster and cluster label are utilized to train the fitness approximation model. The one or more activation functions are applied for training the fitness approximation model. The activation functions applied may include, but is not limited to, rectified linear unit (ReLU) activation function or the like. Further, after the fitness approximation model is trained, the training and validation loss for each epoch is calculated. Further, if the loss is below a pre-determined reference value, the trained model is not saved in the model storage database (not shown). The epoch loss indicates overfitting of solutions in the fitness approximation model. Further, the overfitting of solutions may be restricted in the fitness approximation model. The overfitting of solutions is restricted by, at least, describing an early stop condition which stops training of the fitness approximation model when the epoch loss is below the pre-determined reference value or adding a dropout layer in the fitness approximation model. Lastly, the trained model is saved, if the calculated training and validation loss for each epoch is found to be above the pre-determined reference value. The stored fitness approximation model is thereafter utilized in a next iteration of new solution generation and identification to filter out the unproductive solutions.

At step 218, next iteration of solution generation and identification process is started until a termination condition is met. In an embodiment of the present invention, next iteration of evolution for solution generation and identification is executed after the fitness approximation model and filtering model are re-created and trained. Further, first iteration of solution generation and identification comprises steps of: new generation of population is generated; the fitness of the generated new population is evaluated until the convergence target is reached; solutions are filtered; concrete evaluation is carried out; and the fitness approximation model and filtering model are re-created. The next iteration for solution generation and identification comprising steps of: generation and evolution of converged solutions until further converge by calculating fitness of each generated solution before convergence; converged solutions are filtered; filtered solutions are concretely evaluated and a feedback of concrete evaluation is provided for re-creating and training fitness approximation model and filtering model and for next iteration of evolution process. Further, new population of solutions are generated from reduced search space as the unproductive solutions are identified in the previous iterations. Therefore, from subsequent iterations of evolution the unproductive solutions are identified and rejected, thereby providing reduced search space. The subsequent iterations of evolutions are carried out until a termination condition is met. The termination condition is met when configurable number of solutions associated with the complex problem are identified.

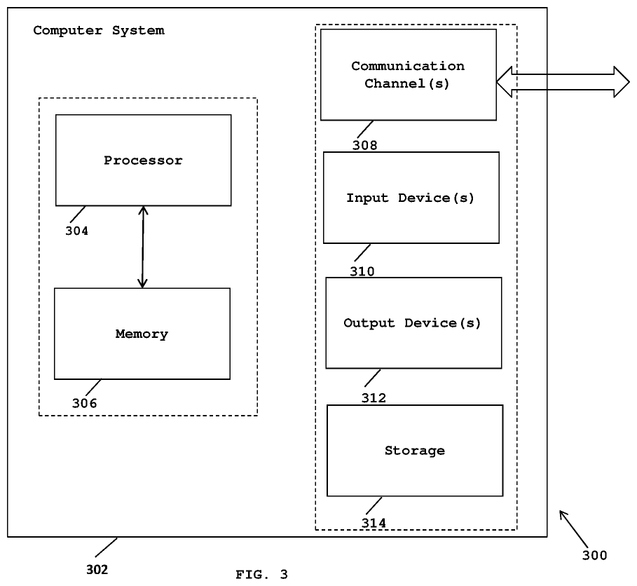

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various software executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for optimizing solution identification for a problem, the method is implemented by a processor executing instructions stored in a memory, the method comprising:
a) generating multiple solutions randomly for the problem by selecting population of one or more datasets from a search space;
b) determining fitness of the each generated solution by utilizing a fitness approximation model for selecting one or more solutions from the generated solutions for generating a next generation of solutions until the solutions converge based on a pre-determined convergence target, wherein the fitness approximation model is created by utilizing one or more seed unproductive solutions;
c) filtering one or more solutions from the converged solutions by utilizing a filtering model for performing a concrete evaluation, wherein the filtering model is created by utilizing one or more seed productive solutions, and wherein the concrete evaluation is performed for identifying one or more productive solutions and one or more unproductive solutions from the one or more solutions filtered from the converged solutions;
d) providing a feedback based on the concrete evaluation related to the one or more unproductive solutions and the one or more productive solutions; and
e) repeating steps a, b, c and d iteratively until a termination condition is met.

2. The method as claimed in claim 1, wherein the datasets are composed of one or more attribute types, wherein the attribute types comprises continuous attributes and categorical attributes.

3. The method as claimed in claim 2, wherein the generation of solutions from the datasets is based on the attribute types of the datasets.

4. The method as claimed in claim 1, wherein the determination of fitness of each of the generated solution determines whether the generated solutions belong to a cluster of known unproductive solutions.

5. The method as claimed in claim 1, wherein the fitness of each of the generated solution is determined by calculating a fitness score for each of the generated solution.

6. The method as claimed in claim 5, wherein the one or more solutions with high fitness score are selected for the next generation.

7. The method as claimed in claim 1, wherein the filtering of the one or more solutions from the converged solutions is based on determining a probability score for each of the one or more solutions in the converged solutions.

8. The method as claimed in claim 7, wherein the determined probability score is representative of similarity of the one or more solutions in the converged solutions to a known cluster of productive solutions.

9. The method as claimed in claim 7, wherein the one or more solutions in the converged solutions is marked as similar to the known cluster of productive solutions if the probability score of the one or more solutions in the converged solutions is higher than a pre-determined probability limit.

10. The method as claimed in claim 9, wherein the one or more solutions in the converged solutions are not utilized for the concrete evaluation if the one or more solutions in the converged solutions are similar to the cluster of known productive solutions.

11. The method as claimed in claim 7, wherein the one or more solutions in the converged solutions are marked as a potential solution for the problem if the probability score of the one or more solutions in the converged solutions is lower than the pre-determined probability limit.

12. The method as claimed in claim 1, wherein the feedback comprising the unproductive solutions and the productive solutions is utilized in re-creating and training the fitness approximation model and the filtering model respectively.

13. The method as claimed in claim 1, wherein the termination condition is met if a configurable number of solutions associated with the problem are identified.

14. An optimization system for solution identification for a problem, the system comprising:
a memory storing program instructions;
a processor configured to execute program instructions stored in the memory; and
a solution identification engine in communication with the processor and configured to:
a) generate multiple solutions randomly for the problem by selecting population of one or more datasets from a search space;
b) determine fitness of the each generated solution by utilizing a fitness approximation model for selecting one or more solutions from the generated solutions for generating a next generation of solutions until the solutions converge based on a pre-determined convergence target, wherein the fitness approximation model is created by utilizing one or more seed unproductive solutions;
c) filter one or more solutions from the converged solutions by utilizing a filtering model for performing a concrete evaluation, wherein the filtering model is created by utilizing one or more seed productive solutions, and wherein the concrete evaluation is performed for identifying one or more productive solutions and one or more unproductive solutions from the one or more solutions filtered from the converged solutions;
d) provide a feedback based on the concrete evaluation related to the one or more unproductive solutions and the one or more productive solutions; and
e) repeat steps a, b, c and d iteratively until a termination condition is met.

15. The system as claimed in claim 14, wherein the solution identification engine comprises a model unit I and a model unit II in communication with the processor, the model unit I is configured to create the fitness approximation model and the model unit II is configured to create the filtering model.

16. The system as claimed in claim 14, wherein the solution identification engine comprises a fitness evaluation unit in communication with the processor, the fitness evaluation unit in communication with the model unit I is configured to determine fitness of each generated solution.

17. The method as claimed in claim 14, wherein the solution identification engine comprises a solution filtering unit in communication with the processor, the solution filtering unit in communication with the model unit II is configured to evaluate each converged solution for determining whether the one or more solutions in the converged solutions belongs to a known cluster of productive solutions.

18. The system as claimed in claim 17, wherein the solution filtering unit is configured to filter the one or more solutions from the converged solutions based on determining a probability score for each of the one or more solutions in the converged solutions.

19. The system as claimed in claim 17, wherein the solution filtering unit is configured not to provide the one or more solutions from the converged solutions for the concrete evaluation if the one or more solutions from the converged solutions are similar to the known cluster of productive solutions.

20. The system as claimed in claim 18, wherein the solution filtering unit is configured to mark one or more solutions from the converged solutions as one or more potential solutions for the problem if the probability score of the one or more solutions in the converged solutions is lower than a pre-determined probability limit.

21. The system as claimed in claim 14, wherein the solution identification engine comprises a concrete evaluation unit in communication with the processor, the concrete evaluation unit is configured to perform the concrete evaluation on the one or more solutions from the converged solutions marked as the potential solutions.

22. The system as claimed in claim 14, wherein the solution identification engine comprises a feedback unit in communication with the processor, the feedback unit is configured to provide the unproductive solutions to the model unit I and the productive solutions to the model unit II utilized in re-creating and training the fitness approximation model and the filtering model respectively.

23. The system as claimed in claim 14, wherein the termination condition is met if a configurable number of solutions associated with the problem are identified.

24. A computer program product comprising:
a non-transitory computer-readable medium having computer program code store thereon, the computer-readable program code comprising instructions that, when executed by a processor, caused the processor to:
a) generate multiple solutions randomly for the problem by selecting population of one or more datasets from a search space;
b) determine fitness of the each generated solution by utilizing a fitness approximation model for selecting one or more solutions from the generated solutions for generating a next generation of solutions until the solutions converge based on a pre-determined convergence target, wherein the fitness approximation model is created by utilizing one or more seed unproductive solutions;
c) filter one or more solutions from the converged solutions by utilizing a filtering model for performing a concrete evaluation, wherein the filtering model is created by utilizing one or more seed productive solutions, and wherein the concrete evaluation is performed for identifying one or more productive solutions and one or more unproductive solutions from the one or more solutions filtered from the converged solutions;
d) provide a feedback based on the concrete evaluation related to the one or more unproductive solutions and the one or more productive solutions; and
e) repeat steps a, b, c and d iteratively until a termination condition is met.
